(19) United States
(12) Patent Application Publication
(10) Pub. No.: US 2025/0293375 A1
(43) Pub. Date: Sep. 18, 2025

(54) CELL MODULE

(71) Applicants: ZHEJIANG JINKO ENERGY STORAGE CO., LTD., Haining City (CN); JINKO ENERGY STORAGE TECHNOLOGY CO., LTD., Haining City (CN)

(72) Inventors: Yuanhang CHEN, Haining City (CN); Guochao CHEN, Haining City (CN); Shaorong GE, Haining City (CN); Yuanfu LV, Haining City (CN)

(21) Appl. No.: 18/744,535

(22) Filed: Jun. 14, 2024

(30) Foreign Application Priority Data
Mar. 15, 2024 (CN) 202420513135.7
Mar. 26, 2024 (CN) 202410350522.8

(51) Int. Cl. H01M 50/262; H01M 50/209; H01M 50/271; H01M 50/298; H01M 50/342

(52) U.S. Cl. CPC H01M 50/262; H01M 50/209; H01M 50/271; H01M 50/298; H01M 50/3425

(57) ABSTRACT

The embodiment of the present disclosure relates to the field of cells and provides a cell module, including: a cell assembly having cell units arranged in a first direction and a second direction, where each respective cell unit of the cell units is provided with an explosion-proof valve at the top of the respective cell unit; and a protection plate located at the top of the cell assembly and including a protection plate body and hollowed-out portions arranged in the protection plate body, where the respective hollowed-out portion includes a break-through portion and at least one connection portion, the at least one connection portion is located around the break-through portion, and the break-through portion is connected to the protection plate body through the at least one connection portion.

### CROSS REFERENCE TO RELATED APPLICATIONS

The present application claims the benefit of priority under the Paris Convention to Chinese Patent Application No. 202410350522.8 filed on Mar. 26, 2024, and to Chinese Patent Application No. 202420513135.7, filed on Mar. 15, 2024, each of which is incorporated herein by reference in its entirety.

### TECHNICAL FIELD

The various embodiments described in this document relate in general to the technical field of cells, and more specifically to a cell module.

### BACKGROUND

As a power storage product, the cell module includes cells inside the cell module for energy storage, and such cells will generate internal heat energy during operation. In order to avoid and reduce the explosion risk of the cell caused by excessive internal pressure or temperature of the cell, the cell is generally equipped with an explosion-proof valve. When thermal runaway occurs in the cell, the heat and electrolyte generated by the cell are sprayed from the explosion-proof valve. However, the electrolyte sprayed to a top surface of the cell is easily to cause safety accidents. For example, the electrolyte can easily cause the cell module to ignite to cause a fire, or the electrolyte can cause a short circuit of the cell.

In the pursuit of high energy density of the cell module, the thermal runaway of the cell module, the number of cells in the module, the fixing of the cells, and the arrangement of heat insulation members between adjacent cells all have impact on the life, performance, and safety of the module. Therefore, there is a need to improve the reliability and safety of the module.

### SUMMARY

In some embodiments, a cell module is provided, which is at least conducive to improving the safety of the cell module.

According to some embodiments, a cell module is provided. The cell module includes a cell assembly having cell units arranged in rows along a first direction and columns along a second direction, where each respective cell unit of the cell units is provided with an explosion-proof valve at a top of the respective cell unit; and a protection plate located at a top of the cell assembly and including a protection plate body and hollowed-out portions arranged in the protection plate body. An orthogonal projection of each respective explosion-proof valve is located within an orthogonal projection of a respective hollowed-out portion of the hollowed-out portions on a plane including the first direction and the second direction. The respective hollowed-out portion includes a break-through portion and at least one connection portion configured to connect the break-through portion to the protection plate body, where the break-through portion, the at least one connection portion, and the protection plate body collectively define at least one first hollowed-out region.

In some embodiments, the break-through portion includes a first end and a second end opposite to the first end, and the at least one connection portion includes a first connection portion corresponding to the first end and a second connection portion corresponding to the second end, the first connection portion being larger in size than the second connection portion. A break-through direction of the respective explosion-proof valve forms an acute angle with a line connecting the first end and a center point of the break-through portion, and forms an obtuse angle with a line connecting the second end and the center point of the break-through portion.

In some embodiments, an area of the orthogonal projection of the respective hollowed-out portion is larger than an area of the orthogonal projection of the respective explosion-proof valve on the plane including the first direction and the second direction.

In some embodiments, a ratio of the area of the orthogonal projection of the respective hollowed-out portion to the area of the orthogonal projection of the respective explosion-proof valve on the plane including the first direction and the second direction is in a range of 1.05 to 1.2.

In some embodiments, the cell module further comprises: a wire harness isolation plate located between the cell assembly and the protection plate. The wire harness isolation plate defines through holes running through the wire harness isolation plate in a thickness direction of the wire harness isolation plate, and an orthogonal projection of the respective explosion-proof valve is located within an orthogonal projection of a respective through hole on the plane including the first direction and the second direction.

In some embodiments, the respective through hole has a size larger than a size of the respective explosion-proof valve and smaller than a size of the respective hollowed-out portion.

In some embodiments, the protection plate further comprises jamming holes. Each respective jamming hole of the jamming holes runs through the protection plate in a thickness direction of the protection plate. The wire harness isolation plate further comprises jamming nails protruding from a surface of the wire harness isolation plate toward the protection plate. Each respective jamming nail has an end close to the protection plate and another end close to the wire harness isolation plate, the end of the respective jamming nail close to the protection plate has a size greater than a size of the respective jamming hole, and the other end of the respective jamming nail close to the wire harness isolation plate has a size less than or equal to the size of the respective jamming hole. The protection plate is fixed with the wire harness isolation plate by cooperation of the respective jamming nail and the respective jamming hole.

In some embodiments, the wire harness isolation plate further comprises at least one protruding portion for each respective through hole of at least one through hole of the through holes. Each of the at least one protruding portion protrudes from the surface of the wire harness isolation plate toward the protection plate, the at least one protruding portion is located around the respective through hole, and the at least one protruding portion forms a flow guidance channel with the respective through hole.

In some embodiments, a respective protruding portion is spaced apart from the protection plate by a gap distance in a range of 0 to 0.2 mm.

In some embodiments, a ratio of a width of the connection portion between adjacent first hollowed-out regions to a thickness of the protection plate body is in a range of 1 to 1.5.

In some embodiments, a ratio of a width of a respective first hollowed-out region between the break-through portion and the protection plate body to a thickness of the protection plate body is in a range of 1 to 1.1.

In some embodiments, the break-through portion defines a second hollowed-out region running through the break-through portion in a thickness direction of the break-through portion.

In some embodiments, the break-through portion includes a material different from a material of the protection plate body.

In some embodiments, the respective hollowed-out portion has a shape of a circle, an oval, a rectangle, or a polygon.

### BRIEF DESCRIPTION OF THE DRAWINGS

One or more embodiments are described as examples with reference to the corresponding figures in the accompanying drawings and the exemplary illustration does not constitute a limitation to the embodiments. Unless otherwise stated, the figures in the accompanying drawings do not constitute a proportion limitation. In order to more clearly explain the embodiments of the present disclosure or the technical solution in the conventional technology, the accompanying drawings required to be used in the embodiments will be briefly described below. Obviously, the accompanying drawings described below are merely some embodiments of the present disclosure, and other accompanying drawings can be obtained from these accompanying drawings for those of ordinary skill in the art without creative efforts.

FIG. 1 is a schematic exploded view of a cell module according to embodiments of the present disclosure.

FIG. 2 is a top view of a protection plate according to embodiments of the present disclosure.

FIG. 3 is a schematic partially enlarged structural diagram of a hollowed-out portion of a protection plate according to embodiments of the present disclosure.

FIG. 4 is a schematic cross-sectional structural diagram of an explosion-proof valve and a protection plate according to embodiments of the present disclosure.

FIG. 5 is a schematic partially enlarged structural diagram of a hollowed-out portion of a protection plate according to other embodiments of the present disclosure.

FIG. 6 is a schematic cross-sectional structural diagram of an explosion-proof valve, a wire harness isolation plate, and a protection plate according to embodiments of the present disclosure.

FIG. 7 is a schematic cross-sectional structural diagram of a wire harness isolation plate and a protection plate according to embodiments of the present disclosure.

FIG. 8 is a schematic partial structural diagram of an energy storage module according to embodiments of the present disclosure.

FIG. 9 is an assembly diagram of a partial structure of an energy storage module according to embodiments of the present disclosure.

FIG. 10 is a structural schematic diagram of a cushioning structure according to embodiments of the present disclosure.

FIG. 11 is a top view of an energy storage module according to other embodiments of the present disclosure.

FIG. 12 is a top view of an energy storage module according to other embodiments of the present disclosure.

### DETAILED DESCRIPTION OF THE EMBODIMENTS

Embodiments of the present disclosure provide a cell module, which is at least conducive to improving the safety of the cell module.

Embodiments of the present disclosure will be described in detail below in conjunction with the accompanying drawings. However, it will be appreciated by those of ordinary skill in the art that in embodiments of the present disclosure, many technical details have been proposed to enable the reader to better understand the present disclosure. However, even without these technical details and variations and modifications based on the following embodiments, the technical solution required to be protected by the present disclosure can be achieved. The cell module provided in this embodiment will be described in detail below in conjunction with the accompanying drawings.

As used herein, features (e.g., regions, structures, devices/members) described as “adjacent” to each other mean and include features, with one or more disclosed identifiers, located closest (e.g., closest) to each other. Additional features (e.g., additional regions, additional structures, additional devices/members) with one or more disclosed identifiers that do not match “adjacent” features may be placed between the “adjacent” features. In other words, the “adjacent” features may refer to that features are directly adjacent to each other, such that no other features interposed between the “adjacent” features. Alternatively, the “adjacent” features may refer to that features are indirectly adjacent to each other, such that at least one feature having an identifier other than an identifier associated with the at least one “adjacent” feature is located between the “adjacent” features.

In the illustration of embodiments of the present disclosure, the technical terms “first” and “second” are only used to distinguish different objects, and cannot be understood as indicating or implying relative importance or implying the number, specific order, or primary and secondary relationship of the indicated technical characteristics. In the illustration of embodiments of the present disclosure, “multiple” means more than two, unless otherwise expressly and specifically defined.

“Embodiments” referred to herein mean that particular features, structures, or characteristics described in connection with embodiments may be included in at least one embodiment of the present disclosure. The presence of the phrase at various locations in the specification does not necessarily refer to the same embodiment, nor is it an independent or alternative embodiment that is mutually exclusive from other embodiments. It is explicitly and implicitly understood by those skilled in the art that the embodiments described herein may be combined with other embodiments.

In the illustration of the embodiment of the present disclosure, the term “and/or” is merely an association relationship describing the association objects, indicating that there may be three relationships. For example, the expression “A and/or B” may include three cases: A exists alone, A and B exist at the same time, and B exists alone. In addition, the character “/” herein generally indicates that related objects are a kind of “or” relationship.

In the illustration of embodiments of the present disclosure, the term “multiple/a plurality of” refers to more than two (including two). Similarly, “multiple/a plurality of groups” refers to more than two groups (including two groups), and “multiple pieces” refers to more than two pieces (including two pieces).

In the illustration of the embodiment of the present disclosure, the orientation or positional relationships indicated by the technical terms “center”, “longitudinal”, “horizontal”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, and “circumferential” are based on the orientation or positional relationships shown in the accompanying drawings, which are merely for the convenience of describing the embodiments of the present disclosure and simplifying the description, rather than indicating or implying that the device/member or component referred to must have a specific azimuth, be constructed and operated in a specific azimuth, and thus should not be understood as a limitation on the embodiment of the present disclosure.

In the illustration of embodiments of the present disclosure, unless otherwise expressly stipulated and limited, the technical terms “installed/disposed”, “connected”, “coupling”, “fixed” and other terms should be understood in a broad sense, for example, they should be understood as fixed connection, detachable connection, or integrally formed. Alternatively, they should also be understood as mechanical connection or electrical connection, or a direct connection, or indirect connection through an intermediate medium, or they should be understood as connection within two elements or an interaction relationship between two elements. For those of ordinary skill in the art, the specific meanings of the above-mentioned terms in embodiments of the present disclosure can be understood according to the specific circumstances.

In the drawings corresponding to embodiments of the present disclosure, the thickness and area of the layers are enlarged for better understanding and for easy description. When a component (such as a layer, film, region, or substrate) is described on another component or on a surface of the other component, the component may be “directly” located on the surface of the other component, or there may be a third component between the two components. On contrast, when one component is described on the surface of another component or when another component is formed or provided on the surface of one component, it means that there is no third component between the two components. Furthermore, when a component is described to be formed “substantially” on another component, it means that the component is not formed on the entire surface (or front surface) of the other component, nor is it formed on a partial edge of the entire surface.

In the illustration of embodiments of the present disclosure, when a component “includes” another component, other components are not excluded unless otherwise stated, and other components may be further included. In addition, when a component such as a layer, film, region, or plate is referred to be “disposed on/above” another component, it may be “directly” on the other component (i.e., on the surface of the other component, and there is no other component between two components), or there may be another component between the two components.

The terms used herein in the illustration of the various embodiments are intended only to describe particular embodiments and are not intended for limiting the embodiments. As used in the description of the various embodiments described and in the appended claims, “the component” is also intended to include component of the plural form, unless the context expressly indicates otherwise. The component includes the layer, the film, the region, the plate, and the like.

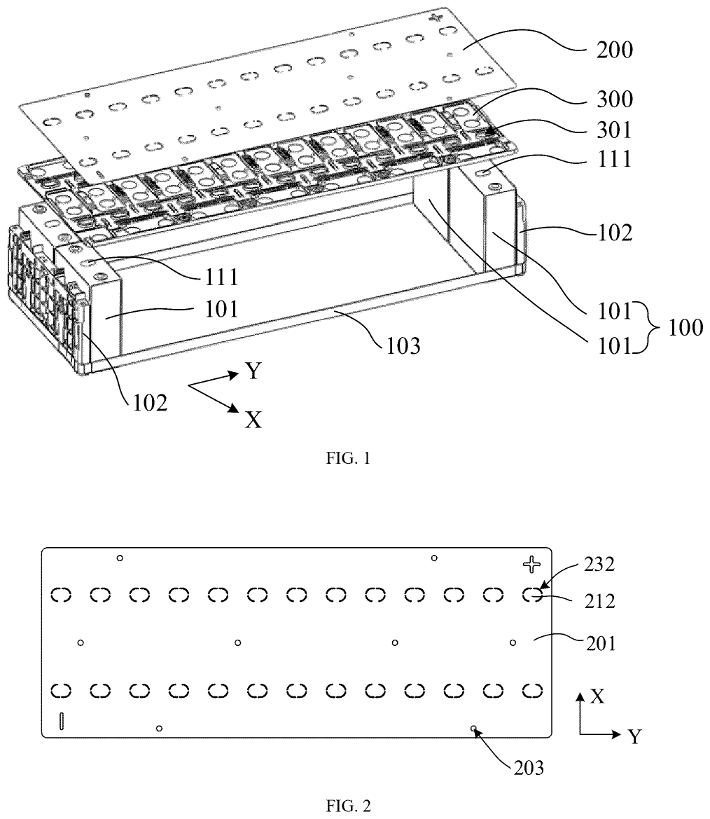

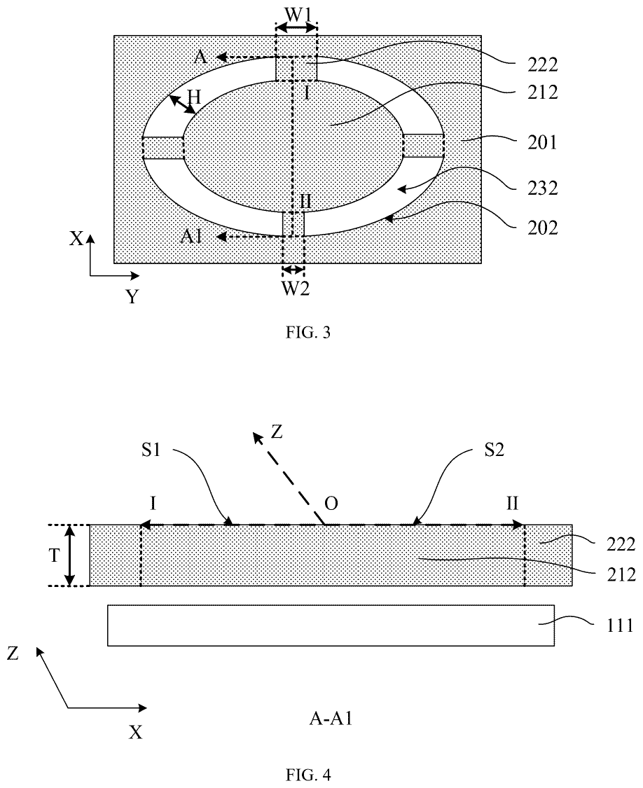

FIG. 1 is a schematic exploded view of a cell module according to embodiments of the present disclosure. FIG. 2 is a top view of a protection plate according to embodiments of the present disclosure. FIG. 3 is a schematic partially enlarged structural diagram of a hollowed-out portion of a protection plate according to embodiments of the present disclosure.

Referring to FIGS. 1 to 3, the cell module includes a cell assembly 100 having a plurality of cell units 101 arranged in rows along a first direction X and columns along a second direction Y and a protection plate 200 disposed at a top of the cell assembly 100. Each respective cell unit 101 is provided with an explosion-proof valve 111 at a top of the respective cell unit 101. The protection plate 200 includes a protection plate body 201 and a plurality of hollowed-out portions 202 arranged in the protection plate body 201. On a plane including the first direction X and the second direction Y, an orthogonal projection of a respective explosion-proof valve 111 is located in an orthogonal projection of a respective hollowed-out portion 202. Each of the plurality of hollowed-out portions 202 includes a break-through portion 212 and at least one connection portion 222 configured to connect the break-through portion 212 to the protection plate body 201. The break-through portion 212 and the at least one connection portion 222 collectively define at least one first hollowed-out region 232 with the protection plate body 201.

In some embodiments, the at least one connection portion 222 is embodied as a plurality of connection portions 222, the plurality of connection portions 222 are spaced apart around the break-through portion 212.

In the cell module provided in the embodiments of the present disclosure, the cell assembly 100 has the plurality of cell units 101 arranged in the first direction X and the second direction Y, where each cell unit 101 is provided with the explosion-proof valve 111 at the top of the cell unit 101, so as to avoid the risk of explosion caused by excessive internal pressure or temperature of the cell unit 101. The protection plate 200 is provided at the top of the cell assembly 100, and the protection plate 200 can be used to isolate the cell assembly 100 from other devices in the cell module. The protection plate 200 includes the protection plate body 201 and the plurality of hollowed-out portions 202 arranged in the protection plate body 201. On the plane including the first direction X and the second direction Y, the orthogonal projection of the explosion-proof valve 111 is located in the orthogonal projection of the hollowed-out portion 202. In other words, the hollowed-out portion 202 is directly facing the explosion-proof valve 111. Each hollowed-out portion 202 has the break-through portion 212 and the at least one connection portion 222, and the break-through portion 212 is connected to the protection plate body 201 only by the at least one connection portion 222 around the break-through portion 212. When ejections are sprayed from the explosion-proof valve 111, the sprayed ejections exert a force, in the direction away from the protection plate body 201, on the break-through portion 212, so that the at least one connection portion 222 is prone to break. Therefore, the ejections and heat can pass through the break-through portion 212 of the protection plate 200 and then to be isolated on the side of the protection plate 200 away from the cell assembly 100, so as to avoid the risk of thermal runaway of the cell module caused by the ejections accumulating between the cell units 101. In addition, there are other devices, such as a battery management system, generally provided on the side of the protection plate 200 away from the cell assembly 100. The battery management system is configured to detect an operation state of the cell assembly 100. Since the break-through portion 212 and the at least one connection portion 222 collectively define the at least one first hollowed-out region 232 with the protection plate body 201, compared with the structure in which the hollowed-out portion 202 is designed to be completely hollow, the break-through portion 212 can block the transfer of part of the heat, and each first hollowed-out region 232 between the break-through portion 212 and the protection plate body 201 is small in size. The heat generated by the cell assembly 100 during normal operation is not easily transferred to the side of the protection plate 200 away from the cell assembly 100 through the at least one first hollowed-out region 232, which can reduce the impact of the heat generated by the cell assembly 100 during normal operation on the operation of the battery management system.

In FIG. 1, for case of explanation, only the first of the plurality of cell units 101 and the last of the plurality of cell units 101 arranged in the second direction Y, and two cell units 101 arranged in the first direction X are shown in the cell assembly 100, which does not constitute a limitation on the number of cell units 101. It shall be understood that in a cell assembly 100, the number of cell units 101 can be designed according to actual needs, as long as the hollowed-out portions 202 on the protection plate 200 and the explosion-proof valves 111 are in one-to-one correspondence with each other. The adjacent cell units 101 may be provided with an insulating plate (e.g., heat insulation and cushioning portion 410 described below). The insulating plate may be configured to isolate the adjacent cells and avoid interaction between the cells. The insulating plate may include a flame-retardant plastic plate, such as polypropylene (PP), acrylonitrile-butadiene-styrene terpolymer (ABS), and polyvinyl chloride (PVC).

In some embodiments, the cell module has an end plate 102 on each of at least one side of the cell assembly 100 in the first direction X. The end plate 102 can isolate the cell assembly 100 from other devices in the cell module, provide an installation space for wiring in the cell module, and dissipate heat for the cell assembly 100, reduce thermal expansion coefficient of the cell module, and reduce the risk of thermal runaway of the cell module.

In FIG. 1, the number of the cell assembly 100 being one is taken as an example. The cell module includes a corresponding end plate 102 on each of two opposite sides of the cell assembly 100 in the first direction X. The end plate 102 can not only provide the installation space for the wiring in the cell module, but also provide a force surface for the cell units 101 when the cell units 101 are tied through a strapping tape 103, so as to avoid damage to the cell units 101 caused by the strapping tape 103 being directly tied to the surface of each of the cell units 101.

In some embodiments, there may be a plurality of cell assemblies arranged in the second direction Y. The cell module further includes an end plate on a side of the first of the plurality of cell assemblies away from other cell assemblies, includes an end plate on a side of the last of the plurality of cell assemblies away from other cell assemblies, and further includes a respective intermediate end plate between each two adjacent cell assemblies. The respective intermediate end plate is configured to isolate the adjacent cell assemblies to avoid heat accumulation between the adjacent cell assemblies. In addition, when the plurality of cell assemblies are tied with strapping tapes, the end plates and the intermediate end plates can withstand the force of the strapping tapes exerted to the cell assemblies, so as to avoid deformation of the cell assemblies after being tied with the strapping tapes.

In some embodiments, each end plate 102 may be made of a plastic material, an aluminum alloy material, a magnesium alloy material, or the like.

In some embodiments, each end plate 102 includes a plurality of stiffener structures to improve the strength of the end plate 102. In some embodiments, the protection plate 200 may be made of a mica sheet material or other materials having insulating, high temperature resistance, and flame-retardant properties.

In the figures provided in this embodiment, each hollowed-out portion 202 may have an elliptical shape. In embodiments of the disclosure, the hollowed-out portion 202 may have any other shape, which is not limited herein. For example, the hollowed-out portion may have a circular shape, a rectangular shape, a polygonal shape, or the like. It shall be understood that, each respective hollowed-out portion 202 directly faces a respective explosion-proof valve 111 in a direction perpendicular to the plane including the first direction X and the second direction Y, such that the shape of the hollowed-out portion 202 can be adjusted according to the shape of the explosion-proof valve 111 or spraying of the ejections.

In some embodiments, on the plane including the first direction X and the second direction Y, an orthogonal projection area of the respective hollowed-out portion 202 is larger than an orthogonal projection area of the respective explosion-proof valve 111. Since the ejections of the explosion-proof valve 111 may splash around the explosion-proof valve 111 when sprayed, the area of the hollowed-out portion 202 is larger than the area of the explosion-proof valve 111, which can prevent the ejections from remaining between the cell assembly 100 and the protection plate 200, thereby avoiding causing a greater safety hazard due to heat or ejections accumulating between the cell units 101.

In some embodiments, on the plane including the first direction X and the second direction Y, a ratio of the orthogonal projection area of the respective hollowed-out portion 202 to the orthogonal projection area of the respective explosion-proof valve 111 is in a range of 1.05 to 1.2, for example, 1.05, 1.07, 1.11, 1.15, 1.18, 1.2, and the like. That is, the area of the hollowed-out portion 202 may be slightly larger than the area of the explosion-proof valve 111, so that the ejections can pass through the hollowed-out portion 202 to reach the side of the protection plate 200 away from the cell assembly 100 after being splashed around the explosion-proof valve 111. In addition, the ratio of the area of the hollowed-out portion 202 to the area of the explosion-proof valve 111 needs to be within an appropriate range, which can prevent the impact force of the explosion-proof valve 111 from being unable to break through the break-through portion 212 when the area of the hollowed-out portion 202 is too large.

In some embodiments, on the plane including the first direction X and the second direction Y, the orthogonal projection area of the respective explosion-proof valve 111 may be less than or equal to the orthogonal projection area of the respective break-through portion 212. In this way, the impact force caused by the ejections of the explosion-proof valve 111 can be concentrated on the break-through portion 212, so that the impact force of the explosion-proof valve 111 can break through the break-through portion 212.

FIG. 4 is a schematic cross-sectional structural diagram of the explosion-proof valve and the protection plate according to embodiments of the present disclosure, where a cross-sectional direction shown in FIG. 4 is the A-A1 direction shown in FIG. 3.

Referring to FIGS. 3 and 4, in some embodiments, the explosion-proof valve 111 may be designed to have a predetermined break-through direction Z, where the break-through direction Z is not perpendicular to the plane including the first direction X and the second direction Y. The break-through portion 212 may include a first end I and a second end II opposite to the first end I. A connection line between the first end I and a center point O of the break-through portion 212 is defined as a first connection line S1, and an angle between the first connection line S1 and the break-through direction Z is an acute angle. A connection line between the second end II and the center point O of the break-through portion 212 is defined as a second connection line S2, and an angle between the second connection line S2 and the break-through direction Z is an obtuse angle. A size (W1 shown in FIG. 3) of the connection portion 222 corresponding to the first end I is larger than a size (W2 shown in FIG. 3) of the connection portion 222 corresponding to the second end II, where the size of the connection portion 222 refers to a width W of the connection portion 222 in a circumferential direction of the break-through portion 212.

It is to be noted that, in FIG. 4, a plane including the break-through direction Z and the first direction X being perpendicular to the plane including the first direction X and the second direction Y is taken as an example. It shall be understood that the break-through direction Z may be any direction, which is not limited in the disclosure. In some embodiments, the break-through direction Z may be set to be not perpendicular and not parallel to the plane including the first direction X and the second direction Y.

Since the break-through direction Z of the explosion-proof valve 111 is not perpendicular to the plane including the first direction X and the second direction Y, the force-bearing direction of the break-through portion 212 is not perpendicular to the plane including the first direction X and the second direction Y, and force exerted to the first end I and force exerted to the second end II of the break-through portion 212 are different. If the size of the connection portion 222 corresponding to the first end I is set to be larger than the size of the connection portion 222 corresponding to the second end II, the force required when the connection portion 222 corresponding to the second end II is broken is smaller than the force required when the connection portion 222 corresponding to the first end I is broken. Therefore, a force-bearing direction in which the break-through portion 212 is easily broken corresponds to the break-through direction of the explosion-proof valve, which can improve the probability of the break-through portion 212 being broken, so as to prevent the ejections of the explosion-proof valve 111 from remaining between the protection plate 200 and the cell assembly 100. In addition, the size of the connection portion 222 corresponding to the first end I is larger than that of the connection portion 222 corresponding to the second end II, so that the force-bearing direction in which the break-through portion 212 is easily broken corresponds to the break-through direction of the explosion-proof valve, and the direction in which the break-through portion 212 is broken is not perpendicular to the plane including the first direction X and the second direction Y, so that the movement trajectory of the break-through portion 212 after being broken and dropped is parabolic, and the dropped break-through portion 212 is not easy to fall back to a region where the hollowed-out portion 202 is located, thereby preventing the dropped break-through portion 212 from blocking the explosion-proof valve 111.

In some embodiments, widths of connection portions at different positions may also be equal in the circumferential direction of the break-through portion.

In some embodiments, a ratio of the width W of the connection portion 222 between adjacent first hollowed-out regions 232 to a thickness T of the protection plate body 201 is in a range of 1 to 1.5, for example, 1, 1.1, 1.3, or 1.5. It shall be understood that the wider the width W of the connection portion 222, the higher the connection strength of the break-through portion 212 and the protection plate body 201, such that the connection portion 222 is not easily to be broken when the break-through portion 212 is impacted by the explosion-proof valve 111. In addition, the narrower the width W of the connection portion 222, the lower the connection strength of the break-through portion 212 and the protection plate body 201, such that the break-through portion 212 is likely to fall onto the explosion-proof valve 111 before being subjected to impact, thereby causing blocking the explosion-proof valve 111. Therefore, the width W of the connection portion 222 between the adjacent first hollowed-out regions 232 needs to be within an appropriate range, when the ratio of the width W of the connection portion 222 to the thickness T of the protection plate body 201 is in the range of 1 to 1.5, it may be conducive to ensuring the break-through portion 212 to be broken when being subjected to impact and maintaining good stability.

In some embodiments, with reference to FIGS. 3 and 4, a ratio of a width H of the respective first hollowed-out region 232 between the break-through portion 212 and the protection plate body 201 to the thickness T of the protection plate body 201 is in a range of 1 to 1.1, for example, 1, 1.01, 1.05, 1.07, or 1.1. The first hollowed-out region is a linear hollowed-out region, i.e., the first hollowed-out region is line-shaped. An extending direction of the first hollowed-out region 232 is a longitudinal direction of the first hollowed-out region 232, and the width H of the first hollowed-out region 232 corresponds to a gap distance between the break-through portion 212 and the protection plate body 201. The wider the width H of the first hollowed-out region 232, the more easily the heat of the cell assembly 100 is transferred to the side of the protection plate 200 away from the cell assembly 100 through the first hollowed-out region 232, which may easily cause other devices on the side of the protection plate 200 away from the cell assembly 100 to be affected by the heat dissipated when the cell assembly 100 operates normally. The smaller the width H of the first hollowed-out region 232, the less favorable the arrangement of the at least one connection portion 222. Therefore, the ratio of the width H of the first hollowed-out region 232 between the break-through portion 212 and the protection plate body 201 to the thickness T of the protection plate body 201 needs to be within an appropriate range.

In some embodiments, the thickness T of the protection plate body 201 may be in a range of 0.5 mm to 1.5 mm, for example, 0.5 mm, 0.8 mm, 1 mm, 1.2 mm, or 1.5 mm. The thickness T of the protection plate 200 is too large, which may cause waste of space and may be not conducive to improving the space utilization rate of the cell module. If the thickness T of the protection plate 200 is too small, the self-strength of the protection plate 200 is relatively low, which may easily cause breaking of the protection plate 200.

It shall be understood that FIG. 3 shows four first hollowed-out regions 232 and four connection portions 222, which does not constitute a limitation on the number of first hollowed-out regions 232 and the number of connection portions 222. In actual design, there may be any other number of first hollowed-out regions 232 and connection portions 222, and the number of first hollowed-out regions 232 and the number of connection portions 222 can be determined according to actual needs. For example, in some embodiments, there may be one first hollowed-out region, the first hollowed-out region has a ring shape, the connection portions are located between two ends of the first hollowed-out region. That is, the break-through portion may be connected to the protection plate body through only one connection portion, and the first hollowed-out region partially surrounds the break-through portion.

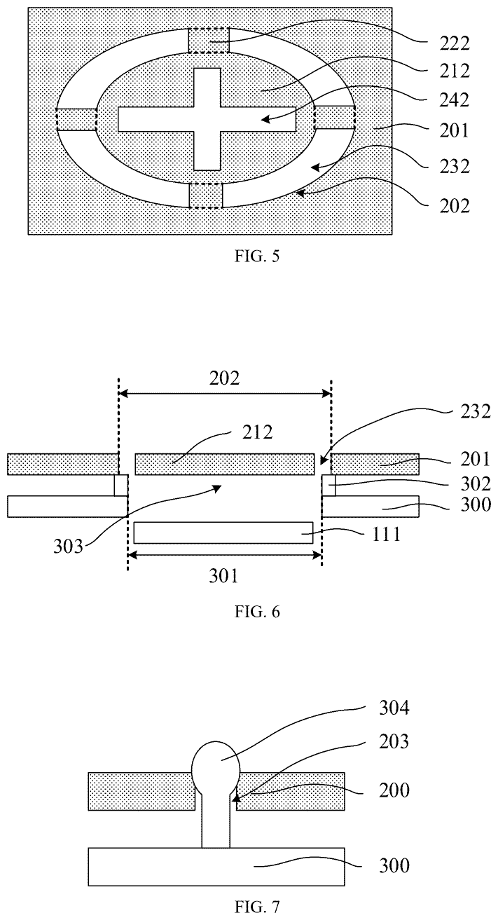

FIG. 5 is a schematic partially enlarged structural diagram of a hollowed-out portion of a protection plate according to other embodiments of the present disclosure.

Referring to FIG. 5, in some embodiments, each break-through portion 212 defines a second hollowed-out region 242 that runs through/penetrates the break-through portion 212 in a thickness direction of the break-through portion 212. In this way, when the break-through portion 212 is impacted by the explosion-proof valve 111 and the at least one connection portion 222 surrounding the break-through portion 212 is not broken, the break-through portion 212 may deform or be broken caused by uneven force-bearing of the break-through portion 212 due to the existence of the second hollowed-out region 242, so as to avoid the risk of thermal runaway of the cell module due to residual ejections concentrating between the cell units 101 caused by that the explosion-proof valve 111 could not break through the break-through portion 212.

In FIG. 5, the second hollowed-out region 242 being in a shape of “cross structure” is taken as an example, which does not constitute the limitation to the shape of the second hollowed-out region 242. In some embodiments, the second hollowed-out region may also have any other shape, which is not limited herein.

In some embodiments, the break-through portion 212 may include a mica sheet material or other materials having insulating, high temperature resistance, and flame-retardant properties.

In some embodiments, the protection plate body 201 may include a mica sheet material or other materials having insulating, high temperature resistance, and flame-retardant properties.

In some embodiments, the material of the break-through portion 212 may be the same as that of the protection plate body 201. The linear hollowed-out regions 232 may be directly defined on the protection plate body 201 by a milling process or a stamping process, such that a material of the at least one connection portion 222 is the same as that of the protection plate body 201.

In some embodiments, the material of the break-through portion 212 may be different from the material of the protection plate body 201. In this way, the break-through portion 212 may be made of other materials, and then fixed to the protection plate body 201 through the at least one connection portion 222, such that the material of the at least one connection portion 222 may be different from that of the protection plate body 201. For example, the material of the protection plate body 201 may be a mica sheet, the material of the break-through portion 212 may be a plastic sheet having insulation, high temperature resistance, and flame-retardant properties, and the material of the at least one connection portion 222 may be an epoxy resin, such that the break-through portion 212 may be fixed to a region where the hollowed-out portion 202 in the protection plate body 201 is located by curing of the epoxy resin.

In some embodiments, the material of the at least one connection portion 222 may be the same as the material of the break-through portion 212. Thus, the at least one connection portion 222 may be integrally formed with the break-through portion 212, and the at least one connection portion 222 may be fixed to the protection plate body 201 by bonding. The protection plate body 201 may be of the same material as the at least one connection portion 222, or may be different from the material of the at least one connection portion 222.

It is to be understood that in FIGS. 3 and 5, in order to distinguish the protection plate body 201, the at least one connection portion 222, and the break-through portion 212, positions of the protection plate body 201, the at least one connection portion 222, and the break-through portion 212 are distinguished by dotted lines, which does not mean that the protection plate body 201, the at least one connection portion 222, and the break-through portion 212 are mutually independent structures. The materials of the protection plate body 201, the at least one connection portion 222, and the break-through portion 212 can be prepared in combination with the selection of the above-mentioned materials and the preparation method.

Referring to FIG. 1, in some embodiments, the cell module may further include a wire harness isolation plate 300 located between the cell assembly 100 and the protection plate 200. The wire harness isolation plate 300 defines a plurality of through holes 301 running through the wire harness isolation plate 300 in a thickness direction of the wire harness isolation plate 300. An orthogonal projection of the respective explosion-proof valve 111 is located in an orthogonal projection of a respective through hole 301 on the plane including the first direction X and the second direction Y.

The wire harness isolation plate 300 can be used to prevent the wiring harness from short-circuiting and staggering, and can effectively isolate electrical signals of different wiring harnesses. Each through hole 301 of the wire harness isolation plate 300 directly faces a respective explosion-proof valve 111. In this way, when the ejections of the explosion-proof valve 111 rushes out, the ejections and heat can pass through the break-through portion 212 and then directly reach the side of the protection plate 200 away from the cell assembly 100 through the through holes 301.

In some embodiments, a size of the through hole 301 is larger than a size of the explosion-proof valve 111 and smaller than the size of the hollowed-out portion 202. The size of the through hole 301 is larger than that of the explosion-proof valve 111, which is advantageous that the ejections of the explosion-proof valve 111 when splashed around the explosion-proof valve 111 can still pass through the break-through portion 212 through the through holes 301 and then reach the side of the protection plate 200 away from the cell assembly 100. Moreover, the size of the through hole 301 is smaller than that of the hollowed-out portion 202, which may facilitate the injection force of the explosion-proof valve 111 towards the break-through portion 212.

FIG. 6 is a schematic cross-sectional structural diagram of an explosion-proof valve, a wire harness isolation plate, and a protection plate according to embodiments of the present disclosure.

Referring to FIGS. 1 and 6, in some embodiments, the wire harness isolation plate 300 may further include at least one protruding portion 302 for each of at least of the plurality of through holes 301, where each of the at least one protruding portion 302 protrudes from a surface of the wire harness isolation plate 300 toward the protection plate 200, and the at least one protruding portion 302 is located around the through hole 301. The at least one protruding portion 302 and the through hole 301 form a flow guidance channel 303. In this way, the ejection force generated by the explosion-proof valve 111 can be centrally aligned with the break-through portion 212 through the flow guidance channel 303, and the ejection and heat generated by the explosion-proof valve 111 can be centrally reached to the side of the protection plate 200 away from the cell assembly 100 through the flow guidance channel 303.

In some embodiments, one through hole 301 may correspond to one protruding portion 302, and the protruding portion 302 may continuously surround the through hole 301. In some embodiments, one through hole 301 may correspond to a plurality of protruding portions 302. That is, the plurality of protruding portions 302 may be spaced around the through hole 301.

In some embodiments, a gap distance between a respective protruding portion 302 and the protection plate 200 is in a range of 0 to 0.2 mm, for example, 0, 0.05 mm, 0.1 mm, 0.15 mm, or 0.2 mm. It shall be understood that, the protruding portion 302 may be in direct contact with the protection plate 200 to abut against the protection plate 200. Alternatively, the protruding portion 302 may also be spaced apart from the protection plate 200 by a gap, where the gap between the protruding portion 302 and the protection plate 200 is in the range of 0 to 0.2 mm, which may be more beneficial for the impact force and the ejection generated by the explosion-proof valve 111 to be more easily concentrated in the flow guidance channel 303.

FIG. 7 is a schematic cross-sectional structural diagram of a wire harness isolation plate and a protection plate according to embodiments of the present disclosure.

Referring to FIG. 7, in some embodiments, the protection plate 200 may further define a plurality of jamming holes 203, where each of the plurality of jamming holes 203 runs through the protection plate 200 in the thickness direction of the protection plate 200. The wire harness isolation plate 300 may further include jamming nails 304 protruding from a surface of the wire harness isolation plate 300 toward the protection plate 200 in a direction close to the protection plate 200. A size of one end of the jamming nail 304 close to the protection plate 200 is greater than a size of the jamming hole 203, and a size of one end of the jamming nail 304 close to the wire harness isolation plate 300 is less than or equal to the size of the jamming hole 203. Therefore, the protection plate 200 and the wire harness isolation plate 300 can be fixed directly by the jamming nail 304 and the jamming hole 203 without additional screws provided. When the protection plate 200 and the wire harness isolation plate 300 are close to each other, one end of the jamming nail 304 close to the protection plate 200 may undergo slight deformation, thereby passing through the jamming hole 203. When the end of the jamming nail 304 close to the protection plate 200 passes through the jamming hole 203, the end of the jamming nail 304 close to the protection plate 200 is restored to an original state, so that the protection plate 200 and the wire harness isolation plate 300 can be kept attached and fixed when the protection plate 200 and the wire harness isolation plate 300 are not subjected to a force to cause the protection plate 200 and the wire harness isolation plate 300 to be away from each other.

It shall be understood that there is a wiring harness (not shown) between the protection plate 200 and the wire harness isolation plate 300, so there is a certain gap between the protection plate 200 and the wire harness isolation plate 300.

In some embodiments, the protection plate 200 and the wire harness isolation plate 300 can also be fixed by bonding or by bolts.

In some embodiments, on the plane including the first direction X and the second direction Y, an overall size of the protection plate 200 is smaller than the overall size of the wire harness isolation plate 300. In this way, it is conducive to the protection plate 200 to play a protective and isolation role on the cell assembly 100 and the wire harness isolation plate 300 as a whole, to prevent the protection plate 200 from affecting the overall size of the cell module.

In the cell module provided in the embodiments of the present disclosure, the cell assembly 100 has the plurality of cell units 101 arranged in the first direction X and the second direction Y, where each cell unit 101 is provided with the explosion-proof valve 111 at the top of the cell unit 101, so as to avoid the risk of explosion caused by excessive internal pressure or temperature of the cell unit 101. The protection plate 200 is provided at the top of the cell assembly 100, and the protection plate 200 can be used to isolate the cell assembly 100 from other devices in the cell module. The protection plate 200 includes the protection plate body 201 and the plurality of hollowed-out portions 202 arranged in the protection plate body 201. On the plane including the first direction X and the second direction Y, the orthogonal projection of the explosion-proof valve 111 is located in the orthogonal projection of the hollowed-out portion 202. In other words, the hollowed-out portion 202 is directly facing the explosion-proof valve 111. The hollowed-out portion 202 has the break-through portion 212 and the at least one connection portion 222, and the break-through portion 212 is connected to the protection plate body 201 only by the at least one connection portion 222 located on the periphery of the break-through portion 212. When ejections are sprayed from the explosion-proof valve 111, the sprayed ejections exert a force on the break-through portion 212 in the direction away from the protection plate body 201, so that the at least one connection portion 222 is prone to break. Therefore, the ejections and heat can break through the break-through portion 212 of the protection plate 200 and be isolated on the side of the protection plate 200 away from the cell assembly 100, so as to avoid the risk of thermal runaway of the cell module caused by the ejections accumulating between the cell units 101. In addition, there are other devices, such as a battery management system, generally provided on the side of the protection plate 200 away from the cell assembly 100. The battery management system is configured to detect an operation state of the cell assembly 100. Since the break-through portion 212 and the at least one connection portion 222 collectively define the at least one first hollowed-out region 232 with the protection plate body 201, compared with the structure in which the hollowed-out portion 202 is completely hollow, the break-through portion 212 can block the transfer of part of the heat, and the first hollowed-out region 232 between the break-through portion 212 and the protection plate body 201 is small in size. The heat generated by the cell assembly 100 during normal operation is not easily transferred to the side of the protection plate 200 away from the cell assembly 100 through the first hollowed-out region 232, which can reduce the impact of the heat generated by the cell assembly 100 during normal operation on the operation of the battery management system.

In addition, in related technologies, the number of cells in the energy storage module, the fixed of the cells, and arrangement of heat insulation members between adjacent cells all may have a greater impact on the life and performance of the energy storage module.

The analysis found that the energy storage module generally includes multiple cells, and multiple cells can be bundled and fixed through fasteners such as steel belts to form the energy storage module. As the number of cells in the energy storage module increases, the difficulty of stability for ensuring the cells in the energy storage module increases accordingly. If the binding strength of fixing members for fixing the cells as the module is insufficient, the cells may sink during the movement and transportation of the module, resulting in deformation of the module. In addition, the structures for heat insulation and cushioning of adjacent cells are mostly heat insulation sheets and cushioning sheets arranged between the adjacent cells by simple stacking, and are fixed between adjacent cells by extrusion between adjacent cells. However, except for friction force of the heat insulation sheets or cushioning sheets, the heat insulation sheet or cushioning sheet does not have additional help for the stability of the fixation of adjacent cells.

Embodiments of the present disclosure provide an energy storage module and a cell pack, which is at least conducive to improving the reliability of the energy storage module.

According to some embodiments of the present disclosure, embodiments of the present disclosure provide an energy storage module. The energy storage module includes a plurality of cells arranged at least in a first direction at intervals; and a plurality of heat insulation and cushioning portions, where each of the plurality of heat insulation and cushioning portions is located at least between a corresponding pair of adjacent cells in the first direction. Each heat insulation and cushioning portion includes a heat insulation sheet and two cushioning structures, where each of the two cushioning structures is located on a corresponding side of two opposing sides of the heat insulation sheet facing a corresponding cell. Each of the two cushioning structures has a hollow, and the hollow runs through the cushioning structure in a thickness direction of the heat insulation sheet. The energy storage module further includes first bonding portions, where each first bonding portion is located at least between a corresponding cushioning structure and the heat insulation sheet facing the first bonding portion, such that the corresponding cushioning structure is bonded and fixed to the heat insulation sheet through the first bonding portion. The energy storage module further includes second bonding portions, where each second bonding portion is located at least between the heat insulation and cushioning portion and the cell facing the second bonding portion. Each of two opposite sides of the heat insulation and cushioning portion is bonded and fixed to a corresponding cell of the adjacent cells through the corresponding second bonding portions in the first direction.

According to some embodiments of the present disclosure, in the cushioning structure and the first bonding portion that are located on each of sides of a respective heat insulation sheet in the first direction, a ratio of an orthogonal projection area of the first bonding portion on the surface of the respective heat insulation sheet to an orthogonal projection area of the cushioning structure on the surface of the respective heat insulation sheet is greater than 0.9.

According to some embodiments of the present disclosure, in the second bonding portion and the cushioning structure that are adjacent to each of sides of the respective cell in the first direction, a ratio of an orthogonal projection area of the second bonding portion on a side surface of the respective cell to an orthogonal projection area of the cushioning structure on the side surface of the respective cell is greater than 0.9.

According to some embodiments of the present disclosure, each cell includes at least a housing and a coil core, the housing has an accommodating cavity, and the coil core is located in the accommodating cavity. The housing has a top surface and a bottom surface that are opposite to each other in a second direction, the coil core has a first top and a first bottom that are opposite to each other in the second direction. The top surface is higher than the first top and the bottom surface is lower than the first bottom in the second direction. The heat insulation and cushioning portion has a second top and a second bottom that are opposite to each other in the second direction. In the second direction, the second top is not lower than the first top, the second top is lower than the top surface, the second bottom is not higher than the first bottom, and the second bottom is higher than the bottom surface.

According to some embodiments of the present disclosure, a plurality of cells spaced apart from each other in the first direction form a cell group, the energy storage module includes a plurality of cell groups arranged at intervals in a third direction, and each two adjacent cells in the third direction are spaced apart from each other by a heat insulation and cushioning portion.

According to some embodiments of the present disclosure, a plurality of heat insulation and cushioning portions arranged in the first direction are disposed between two cell groups adjacent in the third direction, a plurality of heat insulation sheets of the plurality of heat insulation and cushioning portions arranged in the first direction are integrally formed, and/or a plurality of cushioning structures located on a same side of the plurality of heat insulation sheets are integrally formed.

According to some embodiments of the present disclosure, a column of cells arranged in the third direction is deemed as a cell column, a plurality of heat insulation and cushioning portions arranged in the third direction are disposed between two cell columns adjacent in the first direction, a plurality of heat insulation sheets of the plurality of heat insulation and cushioning portions arranged in the third direction are integrally formed, and/or a plurality of cushioning structures arranged on a same side of the plurality of heat insulation sheets are integrally formed.

According to some embodiments of the present disclosure, each cushioning structure includes at least four cushioning strips, the four cushioning strips are sequentially connected end to end to form the cushioning structure, and an orthogonal projection of the cushioning structure on the surface of the heat insulation sheet is in a square shape.

According to some embodiments of the present disclosure, the four cushioning strips are integrally formed, or the four cushioning strips are independent of each other.

According to some embodiments of the present disclosure, embodiments of the present disclosure further provide a cell pack, and the cell pack includes the energy storage module described in the above embodiments.

The technical proposal provided in the embodiments of the present disclosure has at least the following advantages. The energy storage module includes the plurality of cells arranged at intervals in the first direction, and the heat insulation and cushioning portion provided between each two adjacent cells in the first direction, and each heat insulation and cushioning portion includes the heat insulation sheet and cushioning structures located on two opposite sides of the heat insulation sheet. The heat insulation sheet is used for heat insulation of adjacent cells. The cushioning structure is used for coping with the expansion of the cells and avoiding mutual extrusion between the cells. The cushioning structure has the hollow, which is not only conducive to reducing the material consumption of the cushioning structure, but also conducive to improving the cushioning performance of the cushioning structure. The cushioning structure is bonded and fixed on the heat insulation sheet through the first bonding portion. The heat insulation and cushioning portion is bonded and fixed with the side of the cell through the second bonding portion. In this way, the heat insulation and cushioning portion can also achieve fixing of the adjacent cells arranged in the first direction. On basis of this, the plurality of cells are fixed through the fixing member to form the energy storage module, which is not only conducive to effectively alleviating the impact of the thermal expansion and contraction of the cells on the energy storage module, but also conducive to alleviating the phenomenon of the sinking of the cells and improving the structural stability of the energy storage module.

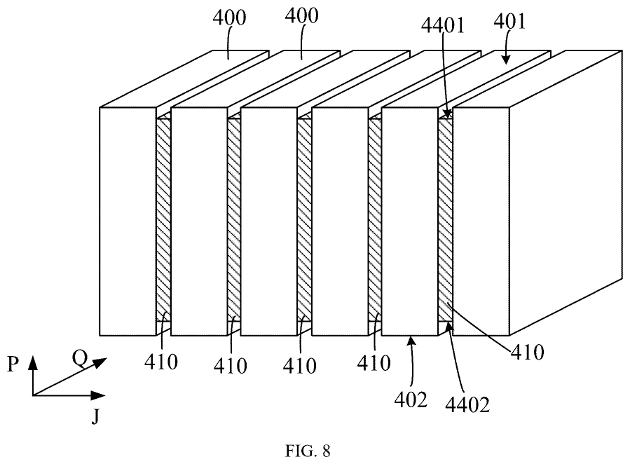

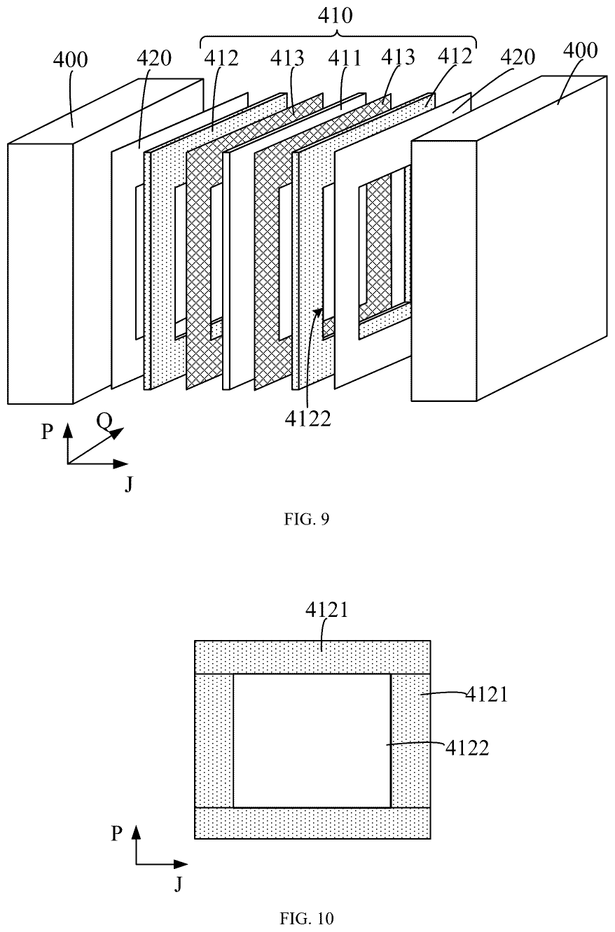

Embodiments of the present disclosure will be described in detail below in conjunction with the accompanying drawings. Referring to FIGS. 8 and 9, the energy storage module provided in the embodiments of the present disclosure includes: a plurality of cells 400 spaced apart from each other at least in a third direction J; and a plurality of heat insulation and cushioning portions 410, where each of the plurality of heat insulation and cushioning portions 410 is located at least between a corresponding pair of adjacent cells 400 in the third direction J. Each heat insulation and cushioning portion 410 includes a heat insulation sheet 411 and two cushioning structures 412, where each of the two cushioning structures 412 is located on a corresponding side of two opposing sides of the heat insulation sheet 411 facing a respective cell 400. Each cushioning structure 412 has a hollow 4122, and the hollow 4122 runs through the cushioning structure 412 in a thickness direction of the heat insulation sheet 411. The energy storage module further includes first bonding portions 413, where each first bonding portion 413 is located at least between a corresponding cushioning structure 412 and the heat insulation sheet 411 facing the first bonding portion 413, such that the corresponding cushioning structure 412 is bonded and fixed to the heat insulation sheet 411 through the first bonding portion 413. The energy storage module further includes second bonding portions 420, where each second bonding portion 420 is located at least between the heat insulation and cushioning portion 410 and the cell 400 facing the second bonding portion 420. Each of two opposite sides of the heat insulation and cushioning portion 410 is bonded and fixed to a respective cell 400 of adjacent cells 400 through the corresponding second bonding portions 420 in the third direction J.

In the heat insulation and cushioning portion 410, the heat insulation sheet 411 is configured to insulate the adjacent cells 400 to prevent thermal runaway of the energy storage module to a certain extent and improve the safety performance of the energy storage module. The cushioning structure 412 is configured to absorb the amount of compression and expansion during the expansion of the cells 400 to avoid mutual extrusion between the cells 400. The cushioning structure 412 has a hollow 4122, which is not only conducive to reducing usage of the material of the cushioning structure 412 to reduce manufacturing costs, but also conducive to improving the cushioning performance of the cushioning structure 412. The cushioning structure 412 is bonded and fixed on the heat insulation sheet 411 through the first bonding portion 413. The heat insulation and cushioning portion 410 is bonded and fixed to the side of the cell 400 through the second bonding portion 420. Compared with the solution in which the dual functions of heat insulation and cushioning are achieved by simply and linearly stacking the heat insulation material and the cushioning material together, in the disclosure, the heat insulation sheet 411 and the heat insulation and cushioning portion 410 are both with glue on double sides, so that the heat insulation and cushioning portion 410 can effectively achieve dual functions of heat insulation and cushioning and can also achieve fixing of the adjacent cells. On basis of this, the plurality of cells 400 are fixed through the fixing member to form the energy storage module, it is not only conducive to effectively alleviating the impact of the thermal expansion and contraction of the cells 400 on the energy storage module, but also conducive to alleviating the phenomenon of the sinking of the cells 400 and improving the structural stability of the energy storage module.

The energy storage module may be a cell module within a cell pack. In some embodiments, one energy storage module may include the plurality of cells 400 arranged at intervals in the third direction J.

In some embodiments, the plurality of cells 400 may be fixed to a lower case in a binding manner by fixing members such as steel belts.

In some embodiments, the cell 400 may be an electrochemical device encapsulated in a housing, and the cell 400 serves as a unit for storing and releasing electrical energy, and converting chemical energy into electrical energy through a chemical reaction. In some embodiments, the cell 400 may include positive electrodes, negative electrodes, a diaphragm, and an electrolyte.

The heat insulation and cushioning portion 410 is configured to achieve heat insulation and cushioning of the adjacent cells 400. By providing the heat insulation and cushioning portion 410 between the adjacent cells 400, it is beneficial to prevent the occurrence of thermal runaway of the energy storage module to a certain extent, and improve the safety performance of the energy storage module. The heat insulation and cushioning portion 410 is further configured to absorb the compression and expansion amount during the expansion of the cells 400, and reduce the mutual extrusion force between the cells 400, which is beneficial to improving the reliability of the energy storage module.

The heat insulating cushion portion 410 includes the heat insulation sheet 411. The heat insulation sheet 411 is made of a material having good heat insulating properties. The heat insulation sheet 411 is a major part of the heat insulating cushion portion 410 for heat insulation. In some embodiments, a material of the heat insulation sheet 411 is mica.

The heat insulation sheet 411 has two opposing surfaces, and the two cushioning structures 412 are respectively located on the two opposing surfaces of the heat insulation sheet 411. The cushioning structures 412 are formed of an elastic compressible material. The cushioning structure 412 is a major part of the heat insulation and cushioning portion 410 that plays a cushioning role. In some embodiments, a material of the cushioning structure 412 is silica gel foam. The cushioning structure 412 has the hollow 4122. The cushioning structure 412 can be cut from a sheet-like cushioning sheet, and the hollow 4122 runs through the cushioning structure in the thickness direction of the cushioning structure.

Compared with a structure in which a whole piece of cushioning sheet as a cushioning component between adjacent cells, in the disclosure, the cushioning structure 412 with the hollow 4122 has fewer material consumption, which is conducive to reducing the manufacturing cost. In addition, the cushioning structure 412 causes a cavity to be defined between the cell 400 and the heat insulation sheet 411, which is more likely to absorb the compression and expansion amount during the expansion of the cell 400, and is conducive to improving the cushioning performance of the heat insulating cushion portion 410.

In some embodiments, the heat insulation sheet 411 may have a thickness in a range of 0.475 mm to 0.525 mm, for example, 0.48 mm, 0.485 mm, 0.49 mm, 0.5 mm, or 0.515 mm.

In some embodiments, an orthogonal projection of the hollow 4122 of the cushioning structure 412 on a surface of the heat insulation sheet 411 may have a circular, square, triangular, or irregular shape.

In some embodiments, a thickness of the cushioning structure 412 in the thickness direction of the heat insulation sheet 411 may be in a range of 0.95 mm to 1.05 mm, for example, 0.98 mm, 0.99 mm, 1 mm, 1.02 mm, or 1.03 mm.

In some embodiments, one cushioning structure 412 has define one hollow 4122. In other embodiments, one cushioning structure 412 has define multiple hollows 4122.

FIG. 10 is a structural schematic diagram of a cushioning structure according to embodiments of the present disclosure.

In some embodiments, referring to FIG. 10, a cushioning structure 412 has one hollow 4122, and an orthogonal projection of the hollow 4122 of the cushioning structure 412 on the surface of the heat insulation sheet 411 may have a square shape. The cushioning structure 412 includes at least four cushioning strips 4121, and the four cushioning strips 4121 are sequentially connected end to end to form the cushioning structure 412. An orthogonal projection of the cushioning structure 412 on the surface of the heat insulation sheet 411 is in a square shape. The square-shaped cushioning structure 412 not only has good cushioning ability, but also has a simple structure, which is conducive to reducing the manufacturing difficulty of the cushioning structure 412.

In some embodiments, the orthogonal projection of the cushioning structure 412 on the surface of the heat insulation sheet 411 in the square shape. The cushioning structure 412 includes four cushioning strips 4121, and the four cushioning strips 4121 are sequentially connected end to end to form the cushioning structure 412, where the four cushioning strips 4121 are integrally formed.

In some embodiments, referring to FIG. 10, the four cushioning strips 4121 are independent of each other. That is, when the cushioning structure 412 is fixed to one surface of the heat insulation sheet 411 through the first bonding portion 413, the four mutually independent cushioning strips 4121 can be sequentially bonded to the surface on one side of the heat insulation sheet 411, and ends of the four cushioning strips 4121 can be sequentially connected, thereby reducing the difficulty of assembling the heat insulating cushion portion 410 and reducing the difficulty of assembling the energy storage module.

The heat insulation and cushioning portion 410 further includes the first bonding portions 413, where each of the first bonding portions 413 is configured to bond and fix a corresponding cushioning structure 412 to the surface of the heat insulation sheet 411, so that the heat insulation sheet 411 and the cushioning structure 412 in the heat insulation and cushioning portion 410 are mutually fixed. In this way, it is possible to prevent the cushioning structure 412 from sliding in a direction parallel to the surface of the heat insulation sheet 411 with respect to the heat insulation sheet 411 and improving the stability of fixing between the cells 400.

In some embodiments, the first bonding portion 413 may be an adhesive layer, for example, UV adhesive, or a flame-retardant acrylic adhesive. The flame-retardant acrylic adhesive has a certain flame-retardant ability. Using the flame-retardant acrylic adhesive as the first bonding portion 413 is conducive to improving the safety of the energy storage module.

In some embodiments, referring to FIG. 9, in the cushioning structure 412 and the first bonding portion 413 located on either side of the heat insulation sheet 411 in the third direction J, a ratio of an orthogonal projection area of the first bonding portion 413 on the surface of the heat insulation sheet 411 to an orthogonal projection area of the cushioning structure 412 on the surface of the heat insulation sheet 411 is greater than 0.9, for example, 0.9, 0.95, 0.97, 0.98, or 1. In this way, it is possible to ensure a high bonding stability between the heat insulation sheet 411 and the cushioning structure 412, and further beneficial to improving the structural stability of the fixed plurality of cells 400 in the energy storage module. The closer the ratio of the orthogonal projection area of the first bonding portion 413 on the surface of the heat insulation sheet 411 to an orthogonal projection area of the cushioning structure 412 on the surface of the heat insulation sheet 411 is to 1, the better the bonding stability between the heat insulation sheet 411 and the cushioning structure 412.

The energy storage module further includes second bonding portions 420, where each of the second bonding portion 420 is configured to bond and fix the heat insulation and cushioning portion 410 to the cell 400, so that the heat insulation and cushioning portion 410 and the adjacent cell 400 are mutually fixed, thereby preventing the heat insulation and cushioning portion 410 from sliding in a direction parallel to the surface of the heat insulation sheet 411 with respect to the cell 400 and improving the stability of fixing between the cells 400.

In some embodiments, the second bonding portion 420 is an adhesive layer, and the adhesive layer may be a UV adhesive or a flame-retardant acrylic adhesive. Using the flame-retardant acrylic adhesive as the second bonding portion 420 is beneficial to improving the safety of the energy storage module.

In some embodiments, in the second bonding portion 420 and the cushioning structure 412 adjacent to either side of the cell 400 in the third direction, a ratio of an orthogonal projection area of the second bonding portion 420 on a side surface of the cell 400 to an orthogonal projection area of the cushioning structure 412 on the side surface of the cell 400 is greater than 0.9, for example, 0.9, 0.95, 0.97, 0.98, or 1. In this way, it is conducive to ensuring high adhesion stability between the heat insulation and cushioning portion 410 and the cell 400, and is conducive to improving the structural stability of fixing of a plurality of cells 400 in the energy storage module. The closer the ratio of an orthogonal projection area of the second bonding portion 420 on a side surface of the cell 400 to an orthogonal projection area of the cushioning structure 412 on the side surface of the cell 400 is to 1, the better the bonding stability between the heat insulation and cushioning portion 410 and the cell 400.

In some embodiments, referring to FIG. 8, each cell 400 includes at least a housing and a coil core (not shown). The housing has an accommodating cavity in which the coil core is located. The housing has a top surface 401 and a bottom surface 402 that are opposite to each other in a fourth direction P, and the coil core has a first top and a first bottom that are opposite to each other in the fourth direction P. The top surface 401 is higher than the first top and the bottom surface 402 is lower than the first bottom in the fourth direction P. The heat insulation and cushioning portion 410 has a second top 4401 and a second bottom 4402 that are opposite to each other in the fourth direction P. The second top 4401 is not lower than the first top, the second top 4401 is lower than the top surface 401, the second bottom 4402 is not higher than the first bottom, and the second bottom 4402 is higher than the bottom surface 402 in the fourth direction P. The core is generally formed by winding the positive electrode sheet and the negative electrode sheet, and the core is the main source of heat in the cell 400 and the main part of the expansion of the cell 400. The heat insulation and cushioning portion 410 is provided on the side surface of the cell 400, so that the size of the heat insulation and cushioning portion 410 is not too large in the fourth direction P, thereby preventing the heat insulation and cushioning portion 410 from interfering with the components provided on the top surface 401 and the bottom surface 402, and reducing the material consumption of the heat insulation and cushioning portion 410 on the premise of achieving effective heat insulation cushioning.

It is to be noted that the second top 4401 is not lower than the first top and the second bottom 4402 is not higher than the first bottom. Since the coil core is the main component of heat and deformation in the cell 400, the heat insulation and cushioning portions 410 are provided between the adjacent coil cores, and it is beneficial to ensure the heat insulation and cushioning portions 410 to effectively insulating and cushion of the adjacent cells 400.

In some embodiments, a distance between the second top 4401 and the top surface 401 in the fourth direction P may be in a range of 10 mm to 20 mm, for example, 10 mm, 12 mm, 15 mm, or 18 mm. In some embodiments, the distance between the second bottom 4402 and the bottom surface 402 in the fourth direction P may be in a range of 10 mm to 20 mm, for example, 10 mm, 12 mm, 15 mm, or 18 mm.

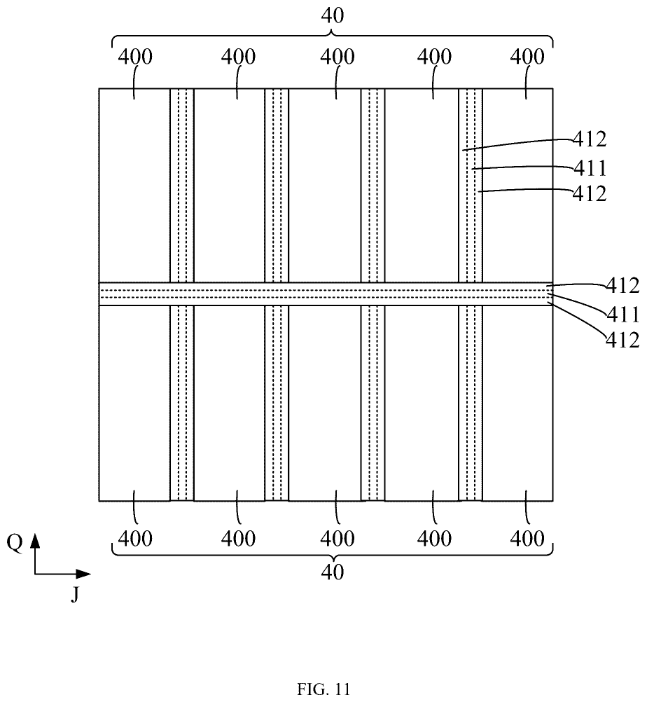

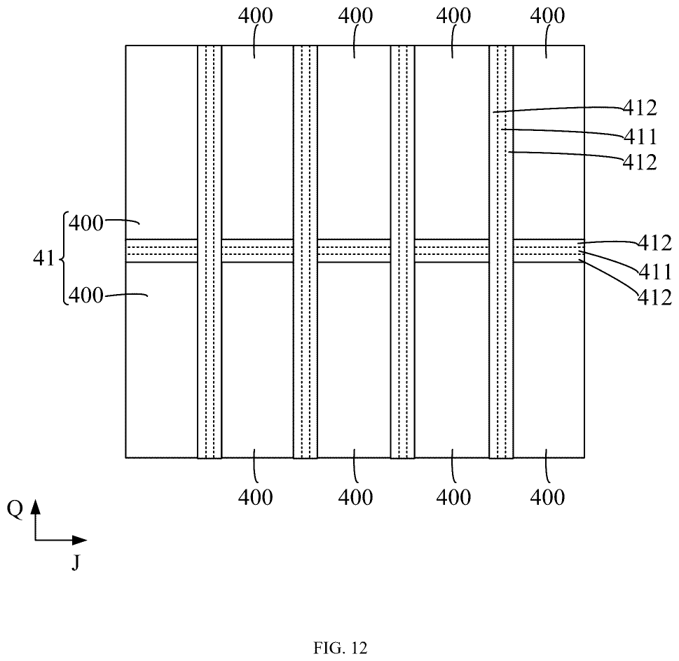

FIG. 11 is a top view of an energy storage module according to other embodiments of the present disclosure. FIG. 12 is a top view of an energy storage module according to other embodiments of the present disclosure.

Referring to FIGS. 11 and 12, in some embodiments, the plurality of cells 400 arranged at intervals in the third direction J form a cell group 40, the energy storage module includes a plurality of cell groups 40 arranged at intervals in a fifth direction Q, and each two adjacent cells 400 are spaced apart from each other by a heat insulation and cushioning portion in the fifth direction Q.

Referring to FIG. 11, in some embodiments, a plurality of heat insulation and cushioning portions arranged in the third direction J are disposed between two cell groups 40 adjacent in the fifth direction Q, a plurality of heat insulation sheets 411 of the plurality of heat insulation and cushioning portions 410 arranged in the third direction J are integrally formed, and/or a plurality of cushioning structures 412 located on a same side of the plurality of heat insulation sheets 411 are integrally formed. In this way, in the process of forming the energy storage module, a plurality of independent cell groups 40 can be formed first, where each cell group 40 includes a plurality of cells 400 arranged at intervals in the third direction J, and a heat insulation and cushioning portion is provided between two adjacent cells 400. Thereafter, the plurality of cell groups 40 are arranged in the fifth direction Q, and a large heat insulation and cushioning portion 410 is provided between two adjacent cell groups 40 in the fifth direction Q. Therefore, assembly difficulty of the energy storage modules can be reduced.

Referring to FIG. 12, in some embodiments, a column of cells 400 arranged in the fifth direction Q is deemed as a cell column 41, a plurality of heat insulation and cushioning portions arranged in the fifth direction Q are disposed between two cell columns 41 adjacent in the third direction J, a plurality of heat insulation sheets 411 of the plurality of heat insulation and cushioning portions arranged in the fifth direction Q are integrally formed, and/or a plurality of cushioning structures 412 located on a same side of the plurality of heat insulation sheets 411 are integrally formed. In this way, in the process of forming the energy storage module, a plurality of independent cell columns 41 can be formed first, where each cell column 41 includes a plurality of cells 400 arranged at intervals in the fifth direction Q, and a heat insulation and cushioning portion is provided between two adjacent cells 400. Thereafter, the plurality of cell columns 41 are arranged in the third direction J, and a relatively large heat insulation and cushioning portion is provided between the two adjacent cell columns 41 in the third direction J, which is conducive to reducing the difficulty of assembling the energy storage module.

In the energy storage module provided in the above embodiments, the heat insulation and cushioning portions bonded and fixed with the cells are used to achieve heat insulation and cushioning of the adjacent cells. Each heat insulation and cushioning portion includes the heat insulation sheet and the cushioning structure. The heat insulation sheet is configured to insulate the adjacent cells to prevent the occurrence of thermal runaway of the energy storage module to a certain extent, and so as to improve the safety performance of the energy storage module. The cushioning structure is configured to absorb the compression and expansion amount in the expansion process of the cells to avoid mutual extrusion between the cells. The cushioning structure has the hollow, which is not only conducive to reducing the material consumption of the cushioning structure and reducing the production cost, but also conducive to improving the cushioning performance of the cushioning structure. The cushioning structure is bonded and fixed on the heat insulation sheet through the first bonding portion. The heat insulation and cushioning portion is bonded and fixed with the side of the cell through the second bonding portion. Compared with the solution in which the dual functions of heat insulation and cushioning are achieved by simply and linearly stacking the heat insulation material and the cushioning material together, in the disclosure, the heat insulation sheet and the heat insulation and cushioning portion are both with glue on double sides, so that the heat insulation and cushioning portion can effectively achieve dual functions of heat insulation and cushioning and can also achieve fixing of the adjacent cells. On basis of this, the plurality of cells are fixed through the fixing member to form the energy storage module, which is not only conducive to effectively alleviating the impact of the thermal expansion and contraction of the cells on the energy storage module, but also conducive to alleviating the phenomenon of the sinking of the cells and improving the structural stability of the energy storage module.

According to another aspect, embodiments of the present disclosure further provide a cell pack. The cell pack includes the energy storage module provided in the above embodiment of the present disclosure. It is to be noted that for the same or corresponding portions as the aforementioned embodiments, reference may be made the above embodiments of the disclosure, which will not be described here in detail.

In some embodiments, the cell pack may include a plurality of energy storage modules electrically connected in sequence.

It is to be noted that in the embodiments provided in FIGS. 1 to 7 and the embodiments provided in FIGS. 8 to 12, similar elements may employ different terminologies, such as, the cell module and the energy storage module, the cell unit 101 and the cell 400, but their positions and functions are similar, respectively, and therefore, the details of the embodiments may be implemented in cooperation with each other without conflict.

When a certain part “includes” another part throughout the specification, other parts are not excluded unless otherwise stated, and other parts may be further included. In addition, when parts such as a layer, a film, a region, or a plate is referred to as being “on” another part, it may be “directly on” another part or may have another part present therebetween. In addition, when a part of a layer, film, region, plate, etc., is “directly on” another part, it means that no other part is positioned therebetween.

In the drawings, the thickness of layers and an area has been enlarged for better understanding and ease of description. When it is described that a part, such as a layer, film, area, or substrate, is “over” or “on” another part, the part may be “directly” on another part or a third part may be present between the two parts. In contrast, when it is described that a part is “directly on” another part, it means that a third part is not present between the two parts. Furthermore, when it is described that a part is “generally” formed on another part, it means the part is not formed on the entire surface (or front surface) of another part and is also not formed in part of the edge of the entire surface.

In addition, the terms “adjacent” means there is no other electrode between the two, what are the two are next to each other in a row was sequence or arrangement. For example, A and B are two of the electrodes in the arrangement of electrodes, and A is adjacent to B means there is no other electrode between A and B, or A and B are next to each other in the arrangement.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise.

Those of ordinary skill in the art will understand that the above embodiments are specific embodiments of the disclosure, and in practical applications, various changes can be made to them in form and detail without deviating from the spirit and scope of the disclosure. Any person skilled in the art can make their own changes and modifications without departing from the spirit and scope of the disclosure, so the protection scope of the disclosure should be based on the scope limited by the claim.

What is claimed is:

1. A cell module, comprising:
a cell assembly having cell units arranged in rows along a first direction and columns along a second direction, wherein each respective cell unit of the cell units is provided with an explosion-proof valve at a top of the respective cell unit; and
a protection plate located at a top of the cell assembly and including a protection plate body and hollowed-out portions arranged in the protection plate body, wherein an orthogonal projection of each respective explosion-proof valve is located within an orthogonal projection of a respective hollowed-out portion of the hollowed-out portions on a plane including the first direction and the second direction, wherein the respective hollowed-out portion includes a break-through portion and at least one connection portion configured to connect the break-through portion to the protection plate body, wherein the break-through portion, the at least one connection portion, and the protection plate body collectively define at least one first hollowed-out region.

2. The cell module of claim 1, wherein the break-through portion includes a first end and a second end opposite to the first end, and the at least one connection portion includes a first connection portion corresponding to the first end and a second connection portion corresponding to the second end, the first connection portion being larger in size than the second connection portion, wherein a break-through direction of the respective explosion-proof valve forms an acute angle with a line connecting the first end and a center point of the break-through portion, and forms an obtuse angle with a line connecting the second end and the center point of the break-through portion.

3. The cell module of claim 1, wherein an area of the orthogonal projection of the respective hollowed-out portion is larger than an area of the orthogonal projection of the respective explosion-proof valve on the plane including the first direction and the second direction.

4. The cell module of claim 3, wherein a ratio of the area of the orthogonal projection of the respective hollowed-out portion to the area of the orthogonal projection of the respective explosion-proof valve on the plane including the first direction and the second direction is in a range of 1.05 to 1.2.

5. The cell module of claim 3, wherein the cell module further comprises:
a wire harness isolation plate located between the cell assembly and the protection plate, wherein the wire harness isolation plate defines through holes running through the wire harness isolation plate in a thickness direction of the wire harness isolation plate, and an orthogonal projection of the respective explosion-proof valve is located within an orthogonal projection of a respective through hole on the plane including the first direction and the second direction.

6. The cell module of claim 5, wherein the respective through hole has a size larger than a size of the respective explosion-proof valve and smaller than a size of the respective hollowed-out portion.

7. The cell module of claim 5, wherein the protection plate further comprises jamming holes, wherein each respective jamming hole of the jamming holes runs through the protection plate in a thickness direction of the protection plate; and
wherein the wire harness isolation plate further comprises jamming nails protruding from a surface of the wire harness isolation plate toward the protection plate, wherein each respective jamming nail has an end close to the protection plate and another end close to the wire harness isolation plate, wherein the end of the respective jamming nail close to the protection plate has a size greater than a size of the respective jamming hole, and the other end of the respective jamming nail close to the wire harness isolation plate has a size less than or equal to the size of the respective jamming hole, wherein the protection plate is fixed with the wire harness isolation plate by cooperation of the respective jamming nail and the respective jamming hole.

8. The cell module of claim 5, wherein the wire harness isolation plate further comprises at least one protruding portion for each respective through hole of at least one through hole of the through holes, wherein each of the at least one protruding portion protrudes from the surface of the wire harness isolation plate toward the protection plate, the at least one protruding portion is located around the respective through hole, and the at least one protruding portion forms a flow guidance channel with the respective through hole.

9. The cell module of claim 8, wherein a respective protruding portion is spaced apart from the protection plate by a gap distance in a range of 0 to 0.2 mm.

10. The cell module of claim 1, wherein a ratio of a width of the connection portion between adjacent first hollowed-out regions to a thickness of the protection plate body is in a range of 1 to 1.5.

11. The cell module of claim 1, wherein a ratio of a width of a respective first hollowed-out region between the break-through portion and the protection plate body to a thickness of the protection plate body is in a range of 1 to 1.1.

12. The cell module of claim 1, wherein the break-through portion defines a second hollowed-out region running through the break-through portion in a thickness direction of the break-through portion.

13. The cell module of claim 1, wherein the break-through portion includes a material different from a material of the protection plate body.

14. The cell module of claim 1, wherein the respective hollowed-out portion has a shape of a circle, an oval, a rectangle, or a polygon.

15. The cell module of claim 1, wherein the cell module has an end plate on each of at least one side of the cell assembly in the first direction.

16. The cell module of claim 15, wherein the end plate includes a plastic material, an aluminum alloy material, or a magnesium alloy material, and the end plate includes a plurality of stiffener structures.

17. The cell module of claim 1, wherein a plurality of cell assemblies are arranged in the second direction, wherein the cell module further comprises an end plate on a side of the first of the plurality of cell assemblies away from other cell assemblies, an end plate on a side of the last of the plurality of cell assemblies away from other cell assemblies, and further includes a respective intermediate end plate between each two adjacent cell assemblies.

18. The cell module of claim 2, wherein the size of the connection portion is a width of the connection portion in a circumferential direction of the break-through portion.

19. The cell module of claim 11, wherein the thickness of the protection plate body is in a range of 0.5 mm to 1.5 mm.

20. The cell module of claim 5, wherein an overall size of the protection plate is smaller than an overall size of the wire harness isolation plate on the plane including the first direction and the second direction.
